(19) United States
(12) Patent Application Publication
(10) Pub. No.: US 2010/0271378 A1
(43) Pub. Date: Oct. 28, 2010

(54) Rapid Activation Of A Device Having An Electrophoretic Display

(76) Inventors: Yun Shon Low, Richmond (CA); Jimmy Kwok Lap Lai, Vancouver (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/429,598

(22) Filed: Apr. 24, 2009

(51) Int. Cl. G06F 3/038; G09G 5/39

(52) U.S. Cl. 345/531; 345/204

(57) ABSTRACT

A method for booting up a system includes detecting a reset condition, and in response to detecting the reset condition, driving a display device having display pixels that have multiple stable states with a reset drive scheme. The reset drive scheme is used to drive the display pixels to a known display state. The driving of the display device may be performed by a display controller. In addition, initialization instructions are executed to place at least one component of the system in an active state. The executing of initialization instructions may be performed by a host. The driving of the display device with the reset drive scheme and the executing of the initialization instructions are performed in parallel. The method may include driving the display device with a first drive scheme to display an initial start-up screen in parallel with the executing of the initialization instructions.

### TECHNICAL FIELD

This application relates to driving or updating electro-optic display devices with display pixels having multiple stable display states.

### BACKGROUND

An electro-optic material has at least two “display states,” the states differing in at least one optical property. An electro-optic material may be changed from one state to another by applying an electric field across the material. The optical property may or may not be perceptible to the human eye, and may include optical transmission, reflectance, or luminescence. For example, the optical property may be a perceptible color or shade of gray.

Electro-optic displays include the rotating bichromal member, electrochromic medium, electro-wetting, and particle-based electrophoretic types. Electrophoretic display (“EPD”) devices, sometimes referred to as “electronic paper” devices, may employ one of several different types of electro-optic technologies. Particle-based electrophoretic media include a fluid, which may be either a liquid, or a gaseous fluid. Various types of particle-based EPD devices include those using encapsulated electrophoretic, polymer-dispersed electrophoretic, and microcellular media. Another electro-optic display type similar to EPDs is the dielectrophoretic display.

Generally, an image is formed on an electro-optic display device by individually controlling the display states of a large number of small individual picture elements or display pixels. A data pixel having one or more bits defines a particular display state of a display pixel. A frame of data pixels defines an image. Commonly, the display pixels are arranged in rows and columns forming a display matrix. An exemplary electro-optic display pixel includes a layer of electro-optic material situated between a common electrode and a pixel electrode. One of the electrodes, typically the common electrode, may be transparent. The common and pixel electrodes together form a parallel plate capacitor at each display pixel, and when a potential difference exists between the electrodes, the electro-optic material situated in between the electrodes experiences the resulting electric field.

An electro-optic display device may have display pixels that have multiple stable display states. Display devices in this category are capable of displaying (a) multiple display states, and (b) the display states are considered stable. With respect to (a), display devices having multiple stable display states include electro-optic displays that may be referred to in the art as “bistable.” The display pixels of a bistable display have first and second stable display states. The first and second display states differ in at least one optical property, such as a perceptible color or shade of gray. For example, in the first display state, the display pixel may appear black and in the second display state, the display pixel may appear white. In addition, display devices having multiple stable display states include devices having display pixels that have three or more stable display states. Each of the multiple display states differ in at least one optical property, e.g., light, medium, and dark shades of a particular color. As another example, a display device having multiple stable states may have display pixels having display states corresponding with 4, 8, 16, 32, or 64 different shades of gray.

With respect to (b), the multiple display states of a display device may be considered to be stable, according to one definition, if the persistence of the display state with respect to display pixel drive time is sufficiently large. The display state of a display pixel may be changed by driving a drive pulse (typically a voltage pulse) on the column data line of the display pixel until the desired appearance is obtained. Alternatively, the display state of a display pixel may be changed by driving the column data line over time with a series of drive pulses regularly spaced in time. In either case, the display pixel exhibits a new display state at the conclusion of the drive time. If the new display state persists for at least several times the minimum duration of the drive time, the new display state may be considered stable. Generally, in the art, the display states of display pixels of LCDs and CRTs are not considered to be stable.

A display device having multiple stable display states may be employed in a variety of devices. Some examples include digital appliances having embedded computer systems, such as electronic readers and cellular telephones. When a user turns on an a digital appliance, the device is generally not activated the instant power is supplied to it. Rather, there is often a delay while the embedded computer system in the device boots up. In some devices the delay may be 10 or 15 seconds. In other devices, the delay may be even longer. These delays may be objectionable to many users.

Accordingly, there is a need for methods and apparatus for rapid activation of a device that includes a display device having multiple stable display states.

### SUMMARY OF DISCLOSURE

A method for booting up a system is disclosed. In one embodiment, the method includes detecting a reset condition, and performing at least one operation in response to detecting the reset condition. One operation includes driving a display device having display pixels that have multiple stable states with a reset drive scheme. The reset drive scheme is used to drive the display pixels to a known display state. The driving of the display device is performed by a display controller. Another operation includes executing initialization instructions to place at least one component of the system in an active state. The executing of initialization instructions may be performed by a host. The driving of the display device with the reset drive scheme and the executing of the initialization instructions are performed in parallel. In one embodiment, the method includes driving the display device with a first drive scheme to display an initial start-up screen. The driving of the display device to display the initial start-up screen is performed in parallel with the executing of the initialization instructions.

In one embodiment, a method for displaying a last user content page in a system, includes storing a last user content page in a first memory in response to a first condition and detecting a reset condition. In response to detecting the reset condition, the method includes driving a display device having display pixels that have multiple stable states with a reset drive scheme. The reset drive scheme is to drive the display pixels to a known display state. The driving of the display device may be performed by a display controller. In addition, the method includes fetching the last user content page from the first memory and driving the display device with a first drive scheme to display the last user content page.

In one embodiment, a display controller includes a first unit to detect a reset condition. In response to detecting the reset condition, the first unit drives a display device having display pixels that have multiple stable states with a reset drive scheme. The reset drive scheme is to drive the display pixels to a known display state. In addition, the first unit provides a ready signal to a host upon detecting a first condition. The host executes initialization instructions to place at least one component of a system in an active state at the same time as the driving of the display device with the reset drive scheme. In one embodiment, the first unit is operable to drive the display device with a first drive scheme to display an initial start-up screen upon completion of the driving of the display device with the reset drive scheme. The host executes initialization instructions to place at least one component of a system in an active state at the same time as the driving of the display device with the first drive scheme.

### BRIEF DESCRIPTION OF THE DRAWINGS

FIG. 1 is a block diagram of a display system having a display device and a display controller having a display memory according to one embodiment.

FIG. 2 is a schematic view of the display device of FIG. 1, the display device having a display matrix.

FIG. 3 is a schematic view of the exemplary display matrix of FIG. 2, the display matrix having display pixels.

FIG. 4 is a diagram illustrating exemplary electrophoretic media disposed between electrodes in an active-matrix arrangement forming one or more display pixels.

FIG. 5 is a timing diagram of an exemplary waveform used to effect a display state transition of a display pixel.

FIG. 6 is a block diagram of the display controller of FIG. 1 according to one embodiment.

FIG. 7 is a block diagram showing the display memory of FIG. 1 and exemplary data paths according to one embodiment.

FIG. 8 is a flow diagram illustrating a pixel synthesis operation according to one embodiment.

FIG. 9 is a flow diagram illustrating a display output operation according to one embodiment.

FIG. 10 is a flow diagram illustrating a first system reset operation.

FIG. 11 is a flow diagram illustrating a system reset operation according to one embodiment.

### DETAILED DESCRIPTION

In the following detailed description of exemplary embodiments, reference is made to the accompanying drawings, which form a part hereof. In the several figures, like referenced numerals identify like elements. The detailed description and the drawings illustrate exemplary embodiments. Other embodiments may be utilized, and other changes may be made, without departing from the spirit or scope of the subject matter presented here. The following detailed description is therefore not to be taken in a limiting sense, and the scope of the claimed subject matter is defined by the appended claims.

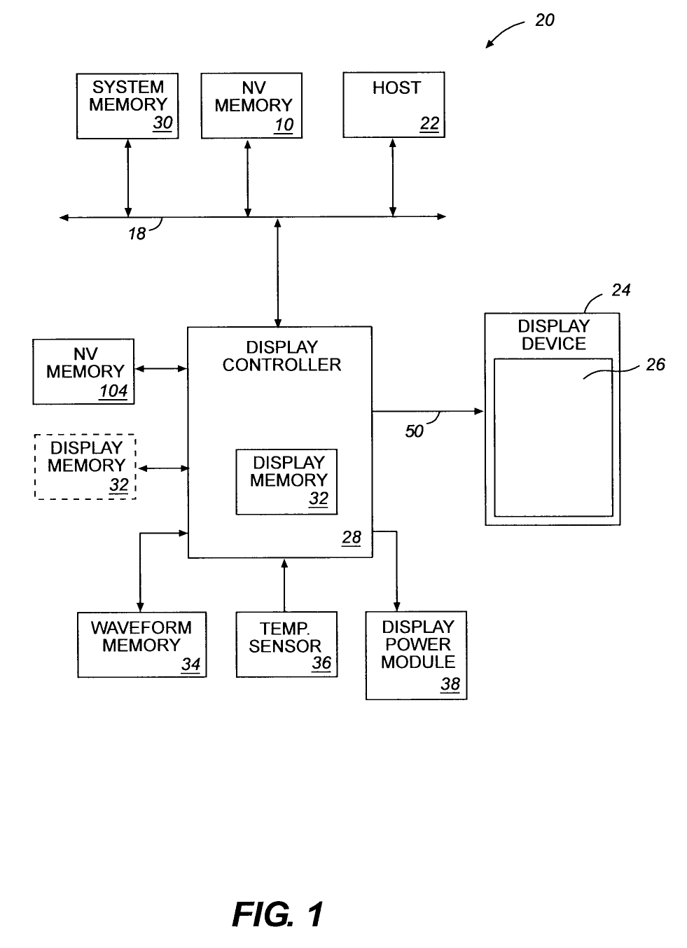

FIG. 1 illustrates a block diagram of an exemplary display system 20 illustrating one context in which embodiments may be implemented. The system 20 includes a host 22, a display device 24 having a display matrix 26, a display controller 28, a system memory 30, and a first non-volatile memory 10. The system 20 also includes a display memory 32, a waveform memory 34, a temperature sensor 36, a display power module 38, and a second non-volatile memory 104. In addition, the system 20 includes a first bus 18, a bus 50, as well as the shown buses interconnecting system components. The system 20 may be any digital system or appliance. In one embodiment, the system 20 is a battery powered (not shown) portable appliance, such as an electronic reader or cellular telephone. FIG. 1 shows only those aspects of the system 20 believed to be helpful for understanding the disclosed embodiments, numerous other aspects having been omitted.

The host 22 may be a general purpose microprocessor, digital signal processor, controller, computer, or any other type of device, circuit, or logic that executes instructions of any computer-readable type to perform operations. Any type of device that can function as a host or master is contemplated as being within the scope of the embodiments.

In one embodiment, the display device 24 may be an electro-optic display device with display pixels having multiple stable display states in which individual display pixels may be driven from a current display state to a new display state by series of two or more drive pulses. In one alternative, the display device 24 may be an electro-optic display device with display pixels having multiple stable display states in which individual display pixels may be driven from a current display state to a new display state by a single drive pulse. The display device 24 may be an active-matrix display device. In one alternative embodiment, the display device 24 may employ a passive-matrix addressing scheme. In one embodiment, the display device 24 may be an active-matrix, particle-based electrophoretic display device having display pixels that includes one or more types of electrically-charged particles suspended in a fluid, the optical appearance of the display pixels being changeable by applying an electric field across the display pixel causing particle movement through the fluid.

In one embodiment, the display controller 28 may be disposed on an integrated circuit (“IC”) separate from other elements of the system 20. In an alternative embodiment, the display controller 28 need not be embodied in a separate IC. In one embodiment, the display controller 28 may be integrated into one or more other elements of the system 20. The display controller 28 is further described below.

The system memory 30 may be may be an SRAM, VRAM, SGRAM, DDRDRAM, SDRAM, DRAM, flash, hard disk, or any other suitable memory. The system memory may store instructions that the host 22 may read and execute to perform operations. The system memory may also store data. The first nonvolatile memory 10 may be a flash memory, EPROM, EEPROM, or any other suitable non-volatile memory.

The display memory 32 may be an SRAM, VRAM, SGRAM, DDRDRAM, SDRAM, DRAM, flash, hard disk, or any other suitable memory. The display memory 32 may be a separate memory unit (shown in dashed lines), such as a separate IC, or it may be a memory embedded in the display controller 28, as shown in FIG. 1. The display memory 32 may be employed to store one frame of pixel data and one frame of synthesized pixel data. In one embodiment, the display memory 32 may store data or instructions.

The waveform memory 34 may be a flash memory, EPROM, EEPROM, or any other suitable non-volatile memory. The waveform memory 34 may store one or more different drive schemes, each drive scheme including one or more waveforms used for driving a display pixel to a new display state. The waveform memory 34 may include a different set of waveforms for one or more update modes. The waveform memory 34 may include waveforms suitable for use at one or more temperatures. The waveform memory 34 may be coupled with the display controller 28 via a serial or parallel bus. In one embodiment, the waveform memory 34 may store data or instructions.

The second non-volatile memory 104 may be a ROM, EPROM, EEPROM, flash memory, or any other suitable memory capable of retaining stored data even when not powered. The non-volatile memory 104 may store instructions for execution by the display controller 28. In one embodiment, the non-volatile memory 104 may store data pixels defining one or more frames. In one embodiment, the non-volatile memory 104 is operable to be written to and read from. In one embodiment, the waveform memory 34 and the non-volatile memory 104 may be combined in a single memory.

The drive pulse (or more typically, the series of drive pulses) required to change the display state of a display pixel to a new display state depends on temperature and other factors. To determine temperature, the temperature sensor 36 is provided. The temperature sensor 36 may be a digital temperature sensor with an integrated Sigma Delta analog-to-digital converter or any other suitable digital temperature sensor. In one embodiment, the temperature sensor 36 includes an I²C interface and is coupled with the display controller 28 via the I²C interface. The temperature sensor 36 may be mounted in a location suitable for obtaining temperature measurements that approximate the actual temperatures of the display pixels of the display device 24. The temperature sensor 36 may be coupled with the display controller 28 in order to provide temperature data that may be used in selecting a display pixel drive scheme.

The power module 38 is coupled with the display controller 28 and the display device 24. The power management unit 38 may be a separate IC. The power module 38 receives control signals from the display controller 28 and generates drive pulses of appropriate voltage (or current) to drive selected display pixels of the display device. In one embodiment, the power management unit 38 may generate voltages of +15V, −15V, or 0V. When drive pulses are not needed, the power module 38 may be powered down or placed in a standby mode.

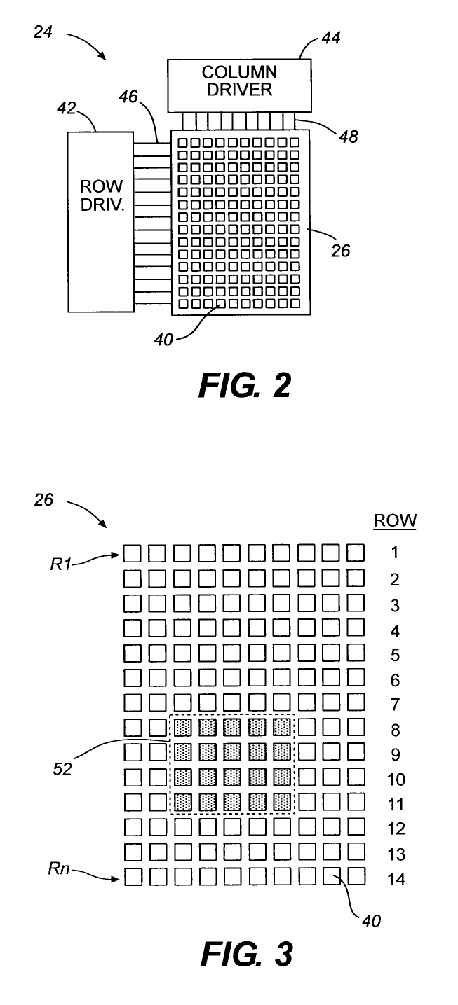

FIG. 2 shows a schematic view of the display device 24. An image may be formed on the display device 24 by individually controlling the display states of a large number of small individual picture elements (“display pixels”) 40. The display device 24 includes a display matrix 26 of display pixels 40.

An active-matrix display includes at least one non-linear circuit element, such as a transistor, for each display pixel. An exemplary active-matrix display pixel includes a thin-film transistor having its drain terminal coupled with the pixel electrode. The gate and source terminals of the transistor are respectively coupled with a row select line and a column data line. To change the display state of the display pixel, the common electrode is placed at ground or some other suitable voltage and a row driver circuit turns on the transistor by driving a suitable voltage on the row select line. An optical-property-dependent voltage corresponding with a display state transition may then be driven on the column data line by a column driver circuit.

In one embodiment, the display device 24 is an active-matrix display. Referring to FIG. 2, each display pixel 40 includes an active switching element (not shown in FIG. 2), such as a thin-film transistor. The switching elements are selected and driven by row driver 42 and a column driver 44. In operation, the row driver 42 may select one of the row select lines 46, turning on all of the switching elements in the row. The column driver 44 may provide a drive pulse on one or more selected column data lines 48, thereby providing a drive pulse to the display pixel located at the intersection of selected row and column lines.

The display device 24 may be coupled with the display controller 28 via one or more buses 50 that the display controller uses to provide pixel data and control signals to the display. The display state of a display pixel 40 is defined by one or more bits of data, which may be referred to as a “data pixel.” An image is defined by data pixels and may be referred to as a “frame.” Commonly, the display pixels are arranged in rows and columns forming a matrix (“display matrix”) 26. There is a one-to-one correspondence between data pixels of a frame and the display pixels 40 of a corresponding display matrix 26.

FIG. 3 shows a schematic view of an exemplary display matrix 26 of display pixels 40. The display device 24 includes a display matrix 26 of display pixels 40 for displaying a frame of pixel data. The display matrix 26 may include any number of rows and columns of display pixels. As one example, the display matrix includes 480 rows and 640 columns. The display matrix 26 includes a first row R1. The display matrix 26 may include one or more submatrices 52. A display submatrix 52 may define a pop-up menu, dialog box, cursor, icon, battery charge level indicator, message indicator, text, or any other type of graphical image. The location of a submatrix may vary with time. The values of the data pixels defining a submatrix may also vary from time to time.

The display pixels 40 of the display matrix 26 of the display device 24 may have multiple stable states. In one embodiment, the display device 24 is a display device having display pixels 40 having three or more stable display states, each display state differing in at least one optical property. In one alternative embodiment, the display device 24 is a bistable display device having display pixels 40 which have first and second stable display states, each state differing from the other in at least one optical property. The display state of a display pixel 40 may be persistent with respect to drive time. In one embodiment, the display state of a display pixel 40 persists for at least two or three times the minimum duration of the drive time. In addition, in one embodiment, the drive pulse required to change the display state of a display pixel 40 from a current display state to a new display state strongly depends on the current display state.

In one embodiment, the display device 24 includes a layer of electro-optic material situated between a common electrode and a pixel electrode. One of the electrodes, typically the common electrode, may be transparent. The common and pixel electrodes together form a parallel plate capacitor, and when a potential difference exists between the electrodes, the electro-optic material situated in between the electrodes experiences the resulting electric field. This general arrangement may be in the form of one parallel plate capacitor at each display pixel, or more than one parallel plate capacitor at each display pixel.

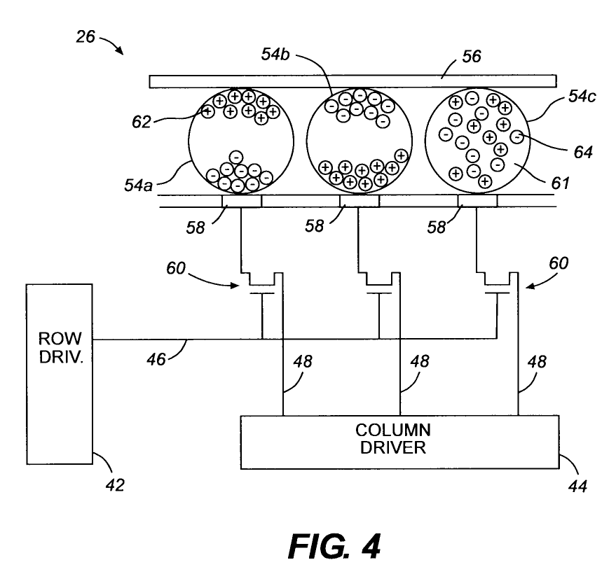

FIG. 4 is a diagram illustrating one exemplary arrangement of one type of electrophoretic media disposed between a common electrode and a pixel electrode, one type of nonlinear circuit element of an active-matrix, and row and column driving circuits. FIG. 4 includes a simplified representation of a portion of the exemplary electrophoretic display 26 in cross-section, a schematic diagram of a portion of the associated nonlinear circuit elements, and a block diagram of row and column driving circuits 42, 44. Referring to FIG. 4, one or more microcapsules 54 are sandwiched between common electrode 56 and pixel electrode 58. The common electrode 56 may be transparent. The drain terminal of a thin-film transistor 60 is coupled with the pixel electrode 58. The gate terminals of the thin-film transistors 60 are coupled with the row driver 42 via row select line 46. The source terminal of each thin-film transistor 60 is coupled with column driver 44 via the column data line 48. Each display pixel may correspond with one microcapsule 54 as shown in FIG. 4, or may correspond with two or more microcapsules (not shown). Each microcapsule 54 may include positively charged white particles 62 and negatively charged black particles 64 suspended in a fluid 61.

To change the display state of a display pixel 40, the common electrode 56 is placed at ground or some other suitable voltage and the row driver circuit 42 turns on all of the transistors 60 in one of the rows by driving a suitable voltage on the row select line 46. The column driver circuit 44 then drives a drive pulse on the column data lines 48 of data pixels having their display state changed. As charge builds up on the common and pixel electrodes 56, 58 an electric field is established across the microcapsule(s) 54 associated with a particular display pixel. When the electric field is positive, the white particles 62 move toward the electrode 56, which results in the display pixel becoming whiter in appearance. On the other hand, when the electric field is negative, the black particles 64 move toward the electrode 56, which results in the display pixel becoming blacker in appearance. The microcapsule 54a is a simplified representation of a display pixel that is completely white and the microcapsule 54b is a simplified representation of a display pixel that is completely black. In addition, the microcapsule 54c illustrates a display pixel having a gray-scale value other than completely white or black, i.e., gray.

So long as charge is stored on the common and pixel electrodes 56, 58 there will be an electric field across the display pixel causing particle movement through the fluid. It will be appreciated that even after the row driver circuit 42 turns a transistor 60 off, or the column driver circuit 44 stops driving a drive pulse on the column data line 48, charge may remain on the common and pixel electrodes 56, 58, i.e., the field does not instantly collapse. In addition, particles 62, 64 may have momentum. Accordingly, particle movement through the fluid may continue for some time after a display pixel has been driven.

While the display state of a display pixel may be changed by having the column driver apply and hold an appropriate drive pulse on the column data line 48 until the desired display state is obtained in a single time interval, alternative methods may be employed for changing the display state of a display pixel. Various alternative methods provide for driving a series of drive pulses over time. In these methods, the display matrix 26 is refreshed or updated in a series of two or more “drive frames.” For each drive frame in the series, each row is selected once, allowing the column driver 44 to drive a drive pulse onto each display pixel of the selected row having its display state changed. The duration of time that each row is selected may be identical so that each drive frame in the series is of identical duration. Thus, instead of changing the display state of a display pixel with a single drive pulse in a single time period, the display state may be changed by driving a series of drive pulses in a series of time periods regularly spaced in time.

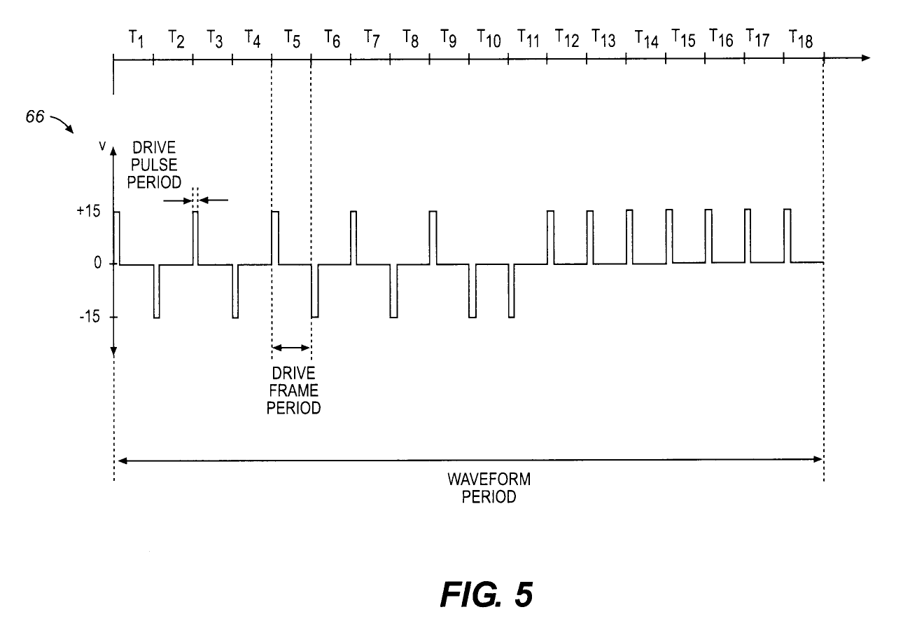

FIG. 5 shows an exemplary waveform 66. The term “waveform” may be used in this description to denote the entire series of drive pulses occurring in a series of time periods regularly spaced in time that are used to cause a transition from some initial display state to a final display state. A waveform may include one or more “pulses” or “drive pulses,” where a pulse or a drive pulse generally refers to the integral of voltage with respect to time, but may refer to the integral of current with respect to time. The term “drive scheme” may be used in this description to refer to a set of waveforms sufficient to effect all possible transitions between display states for a specific display device under particular environmental conditions.

The waveform 66 is provided for the purpose of illustrating features of waveforms generally and for defining terms. The waveform 66 is not intended to depict an actual waveform. The time periods shown in FIG. 5 are not intended to be to scale. The time period in which a single drive pulse is driven may be referred to as the “drive pulse period.” In one embodiment, the drive pulse periods are of identical duration. The time period in which all of the lines of a display matrix 26 are addressed once may be referred to as the “drive frame period.” In one embodiment, each drive frame period is of identical duration. The time associated with the entire series of drive frame periods may be referred to as the “waveform period.” The “drive time” of a display pixel 40 may be equal to a waveform period.

The display device 24 may make use of multiple drive schemes. For example, the display device 24 may use a gray scale drive scheme (“GSDS”), which can be used to cause transitions between all possible gray levels. In addition, display device 24 may use a monochrome drive scheme (“MDS”), which can be used to cause transitions only between two gray levels, e.g., black or white. Further, the display device 24 may use a pen update mode (“PU”), which can be used to cause transitions having an initial state that includes all possible gray levels and a final state of either black or white. The MDS and PU drive schemes typically provide quicker rewriting of the display than the GSDS drive scheme. A drive scheme may be selected based on the type of display state transitions that are needed. For instance, if display pixels may take any one of 16 gray levels and the region being updated includes display pixels transitioning from 10 to 15, then the GSDS drive scheme must be used. However, if the region being updated includes display pixels transitioning from 10 to 0, or 10 to 15, then either the GSDS or PU drive schemes may be used. Because the PU drive scheme is faster than the GSDS drive scheme, the PU drive scheme would generally be used. In alternative embodiments, any number of display states may be provided, e.g., 2, 4, 8, 32, 64, 256, etc. While the display device 24 may make use of the GSDS, MDS, PU, and other drive schemes to drive a display pixel to a new display state when the current display state is known, a different drive scheme is required when the current display state of a display pixel is unknown

The display device 24 may use a reset (“RST”) drive scheme when the current display state of a display pixel is unknown. In one embodiment, an RST drive scheme may alternately drive a display pixel to its two extreme display states. For example, the extreme display states of a display pixel may be black and white. The RST drive scheme may alternately drive a display pixel to a black state and then to a white state, or to a white state and then to a black state. Driving a pixel to a black state and then to a white state in succession, or visa versa, may be referred to as “flashing” the display pixel. A RST drive scheme may flash a display pixel or, more commonly, the entire display matrix 26 of display pixels 40 two or more times in succession. In one embodiment, the RST drive scheme may flash a display pixel five or more times in succession. When applied to the entire display matrix 26, an RST drive scheme may end with the display device having an all white or black appearance. An RST drive scheme is used to ensure that when drive schemes such as the GSDS, MDS, PU drive schemes are subsequently used, the display pixels 40 accurately transition to new display states. Drive schemes other than a drive scheme that exclusively drives a display pixel to its two extreme display states may be employed to drive a display pixel to a known state. As used herein, a reset drive scheme may be any drive scheme that accurately drives a display pixel from an unknown display state to a known display state. Generally, a RST drive scheme may take a significantly longer time to complete than the GSDS, MDS, PU drive schemes. In one embodiment, the RST drive scheme may take about four seconds to complete.

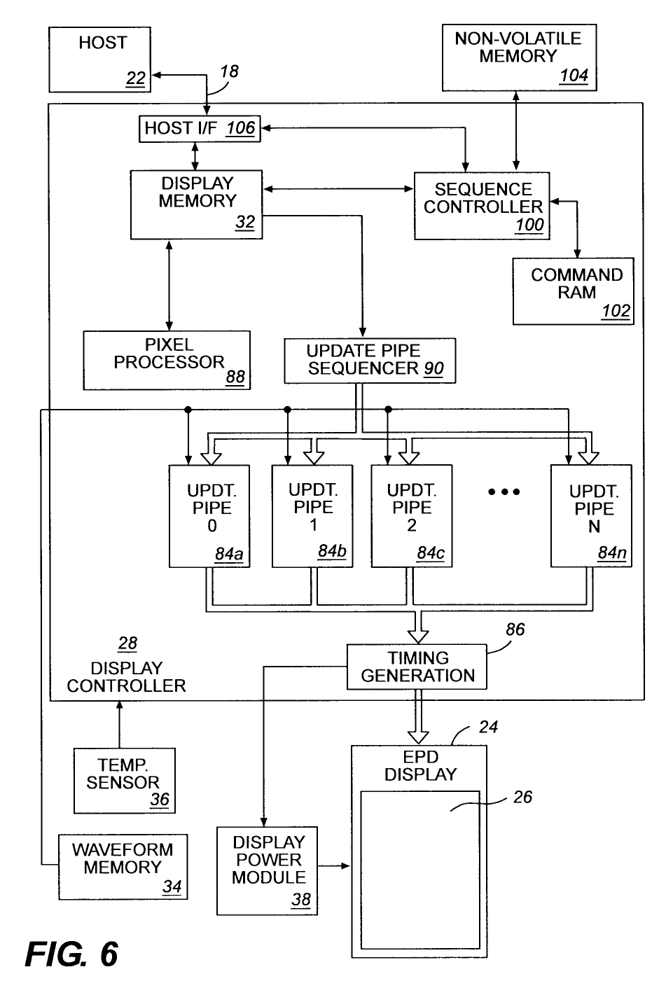

FIG. 6 shows the display controller 28 of FIG. 1, according to one embodiment, in greater detail. The display controller 28 may include the display memory 32, one or more update pipes 84, a timing generation unit 86, a pixel processor 88, an update pipe sequencer 90, and a host interface 106. In addition, the display controller 28 may include a sequence controller 100 and a command RAM 102.

Use of the display controller 28 permits the image displayed on a bistable, electro-optic display device to be divided into two or more regions and each of the regions may be updated in separate display update operations. Each display update operation may use a different drive scheme or update mode, and the display update operations may overlap in time. Each display update operation may use a different update pipe 84. The updating of a first region of the display matrix using a first update mode can begin even while a display update operation for updating a second region using a second update mode is in progress.

The display memory 32 may be coupled with the host 22 via the host interface 106. In addition, the display memory 32 may be coupled with pixel processor 88, the update pipe sequencer 90, and the sequence controller 100. In addition, the sequence controller 100 may be coupled with the host 22 via the host interface 106. The sequence controller 100 may be coupled with the second NV memory 104 and the command RAM 102.

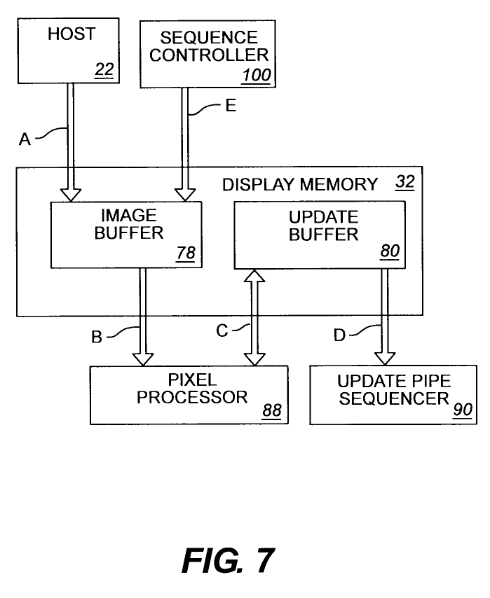

FIG. 7 is a block diagram showing the display memory 32, according to one embodiment, in greater detail, and exemplary data paths between the display memory 32 and the host 22, the pixel processor 88, and update pipe sequencer 90. In one embodiment, the display memory 32 includes an image buffer 78 and an update buffer 80. The host 22 may write to the image buffer 78 via data path “A.” (Although not shown in FIG. 7, the host 22 may also read from the display memory 32.) Further, the sequence controller 100 may write to the image buffer 78 via data path “E.” In a pixel synthesis operation, the pixel processor 88 may read from the image buffer 78 via data path “B.” In addition, the pixel processor 88 may read from and write to the update buffer 80 via data path “C.” In a display update operation, the update pipe sequencer 90 may read from the update buffer 80 via data path “D.”

The image buffer 78 may be used to store a frame of data pixels, e.g., a main image. The update buffer 80 may be used to store synthesized pixels. In one embodiment, a “synthesized pixel” is a data structure or a data record that defines a pixel transition. A synthesized pixel may include data defining a current display state and a next display state. A synthesized pixel may additionally include an identifier of an assigned update pipe 84.

The host 22 may store a full frame of data pixels or a portion of a frame of data pixels in the image buffer 78 using data path A. In addition, the sequence controller 100 may store a full frame of data pixels or a portion of a frame of data pixels in the image buffer 78 using data path E. The pixel processor 88 may include an operability to generate synthesized pixels. In a pixel synthesis operation, the pixel processor 88 may read a data pixel stored in the image buffer 78 to obtain data defining a next display state of a display pixel 40 using data path B. In one embodiment, the pixel processor 88 may read a synthesized pixel stored in the update buffer 80 to obtain data defining a current display state of a display pixel 40 using data path C. The pixel processor 88 may use the data pixel obtained from the image buffer 78 and the synthesized pixel obtained from the update buffer 80 to generate a new synthesized pixel. The pixel processor 88 may store synthesized pixels that it generates in the update buffer 80 using data path C. The storing of a synthesized pixel in the update buffer 80 by the pixel processor 88 may overwrite a previously stored synthesized pixel.

Data pixels 40 defining an image may be stored in the image buffer 78. In one embodiment, the host 22 may store data pixels 40 in the image buffer 78 using data path A. In an alternative embodiment, another device may store data pixels in image buffer 78. Alternatively, a unit internal to the display controller 28, such as the sequence controller 100, may cause data pixels to be stored in the image buffer 78. In a display update operation, a display update command is sent, transmitted, or communicated to the display controller 28. The display update command may be sent by the host 22, by another device, or may be generated internally by the display controller 28, such as by the sequence controller 100. The display update command causes the display states of the display pixels 40 of the display matrix 26 to be updated. In response to the display update command, the display controller 28 performs: (a) a pixel synthesis operation; and (b) a display output operation.

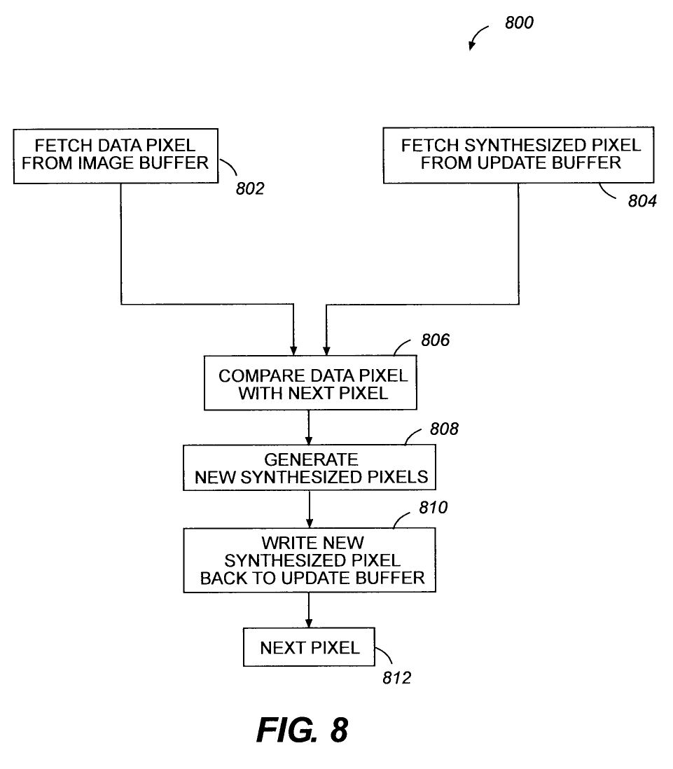

FIG. 8 is a flow diagram illustrating a pixel synthesis operation 800 according to one embodiment. In one embodiment, the pixel synthesis operation 800 may be performed by the pixel processor 88. In an operation 802, a data pixel is read or fetched from the image buffer 78. Data pixels may be read from the image buffer 78 in raster order beginning with the data pixel 40 in the upper left corner of the display matrix 26 according to one embodiment. In an operation 804, a synthesized pixel is read or fetched from the update buffer 80. Synthesized pixels may be read from the update buffer 80 in raster order beginning with the synthesized pixel corresponding with the data pixel in the upper left corner of the display matrix 26 according to one embodiment. The operation 802 may be performed prior to the operation 804, the operation 804 may be performed prior to the operation 802, or the operations 802 and 804 may be performed at the same time.

In operation 806, the fetched data pixel is compared with a next pixel value. The next pixel value is obtained from the synthesized pixel fetched in operation 804. A next pixel value is included in the data structure of each synthesized pixel and represents the current display state of a corresponding display pixel. Operation 806 compares the data pixel and the next pixel value to determine if they are equal. If the values are equal, the next and current display states are identical, and the corresponding display pixel is not marked for updating. On the other hand, if the values differ, the next and current display states differ, and the corresponding display pixel is marked for updating.

In operation 808, a new synthesized pixel may be formed or generated. If the display pixel was not marked for updating in operation 806, a new synthesized pixel need not be formed. If the display pixel was marked for updating, the next pixel value obtained from the fetched synthesized pixel (operation 804) is set as the current pixel value in the new synthesized pixel. The value of the fetched data pixel (operation 802) is set as the next pixel value in the new synthesized pixel. In operation 810, the new synthesized pixel is written back to the update buffer 80. As indicated by operation 812, the pixel synthesis operation 800 repeats operations 802-810 for each pixel location in the display matrix 26 according to one embodiment.

Referring again to FIGS. 6 and 7, the update pipe sequencer 90 may include an operability to perform one of the functions required in a display output operation. The update pipe sequencer 90 may fetch synthesized pixels from the update buffer 80 using data path D. The update pipe sequencer 90 may fetch synthesized pixels in raster order. The update pipe sequencer 90 may provide a synthesized pixel that it fetches to one of the update pipes 84. The update pipe sequencer 90 may determine which update pipe 84 to provide the synthesized pixel to by inspecting an update pipe identifier included in the synthesized pixel data structure.

In one embodiment, an update pipe 84 locates a drive scheme stored in the waveform memory 34 corresponding with a designated update mode and a current temperature. For each drive frame in the waveform period, the update pipe 84 copies all possible drive pulses for the drive scheme for the current drive frame and stores the current drive frame pulses in a lookup table associated with the update pipe. The update pipe 84 uses the current and next display states of a synthesized pixel to locate drive pulse data in the lookup table and stores the pulse data in a first-in-first-out memory (“FIFO”) memory, which may be included within the update pipe. The FIFO memory is provided so that pulse data may be generated and buffered ahead of when it will be needed by the timing generation unit 86. The FIFO may be provided with one or more status flags that indicate the amount of drive pulse data present in the FIFO, e.g., full, half full, empty, etc.

The timing generation unit 86 includes an input that is coupled with the outputs of the update pipes 84. The timing generation unit 86 receives waveform data from the update pipes 84. The timing generation unit 86 provides waveform data to the display power module 38 and the display device 24 according to the timing requirements of the display device 24.

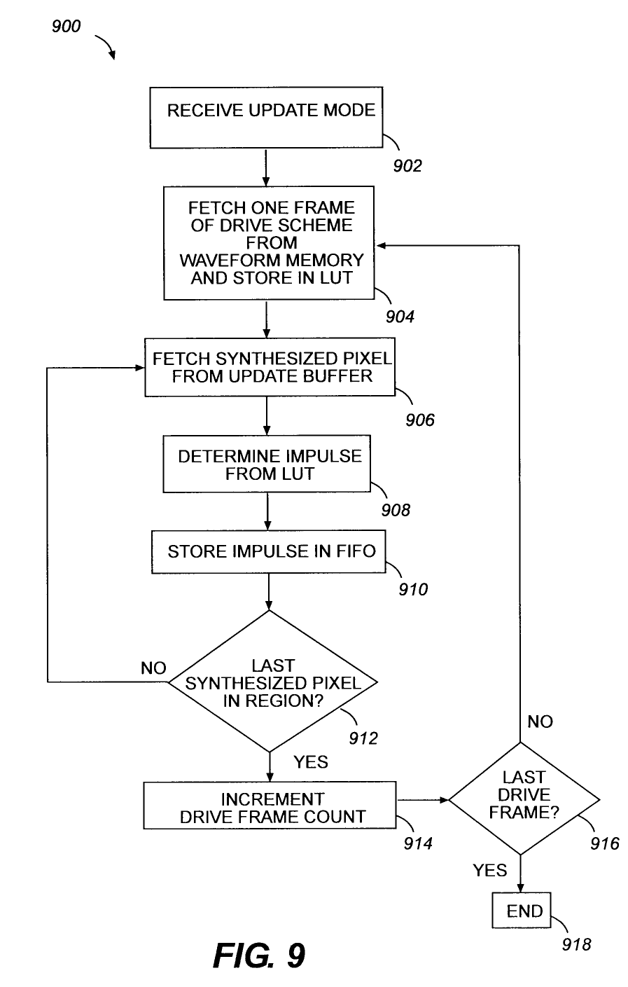

FIG. 9 is a flow diagram illustrating a display output operation according to one embodiment. In an operation 902, an update mode or drive scheme is received. In operation 904, one drive frame of the corresponding drive scheme is fetched from the waveform memory 34. Drive pulses for the current drive frame period may be stored in a lookup table (“LUT”). In operation 906, a synthesized pixel is fetched from the update buffer 80. Synthesized pixels of the display matrix 26 may be fetched from the update buffer 80 in raster order. In one embodiment, synthesized pixels of a submatrix 26 may be fetched in raster order. In operation 908, a drive impulse is determined for the fetched synthesized pixel. The drive impulse may be determined using the lookup table. In operation 910, the drive impulse may be stored in a FIFO memory that may be provided within an update pipe 84. In operation 912, a determination is made if the current synthesized pixel corresponds with the last pixel location in the update region. The update region may be the display matrix 26 or the submatrix 52. If not the last pixel location, steps 906-910 are repeated for each additional synthesized pixel in the update region. If the current synthesized pixel is the last synthesized pixel, a drive frame count is incremented in operation 914. In operation 916, a determination is made whether the current drive frame is the last drive frame in the drive scheme. If not the last drive frame period, steps 904-910 are repeated for each remaining drive frame period of the drive scheme.

The sequence controller 100 is operable to receive commands and to execute instructions associated with a received command. The command RAM 102 may store instructions that may be executed by the sequence controller 100 in response to receiving a particular command. The sequence controller 46 may include a state machine and registers. In operation, the host 22 may store a command and command parameters in the sequence controller's registers. When the sequence controller 100 detects a write to one of its registers it starts fetching instructions from the command RAM 102 which are associated with the particular command. The sequence controller 100 may be used to write to or read from one or more registers within the display controller 28 or within a device coupled with the display controller, such as the display device 24 in response to a single command from the host 22. Accordingly, the sequence controller 100 may be used to configure the display controller 28 or the temperature sensor 36 during a reset operation. In addition, during a reset operation, the sequence controller 100 may be hardwired to read one or more commands, or data, stored in the non-volatile memory 104.

The system 20 may be used in many different applications. When power is first supplied to a device having an EPD, various components need to be initialized in a boot sequence or reset operation. In addition, a system reset operation may be desired from time to time during use of an EPD device for various reasons, such as encountering a problem with some system function. If a system reset operation is performed, the device is not usable until a boot sequence completes. It is not uncommon for boot sequences in devices like an electronic reader or a cellular telephone to take 10-15 seconds or longer. The time needed to complete a reset operation may be objectionable to many users. It would be desirable if the time needed to complete a reset operation could be reduced from that which is currently required.

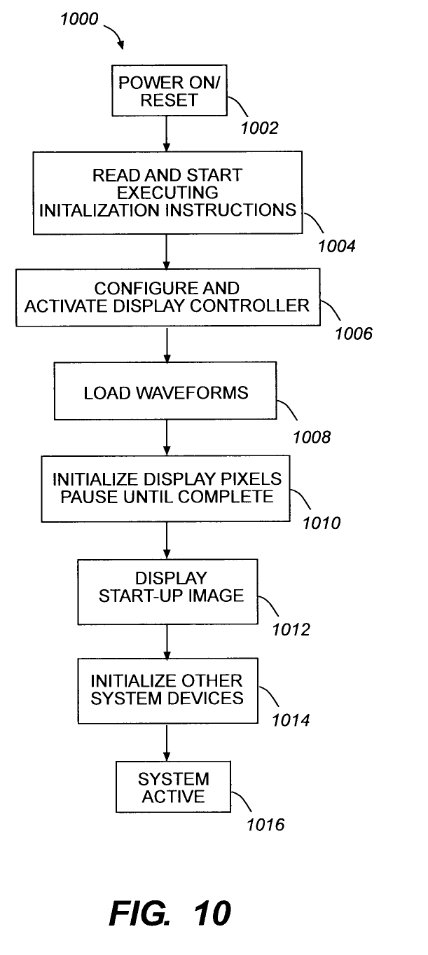

FIG. 10 is a flow diagram illustrating a first system reset operation 1000. In an operation 1002, power is supplied to a system, such as by a user pushing an on/off button. In one alternative, the reset operation may be initiated in a system in which power is currently being supplied, such as by a user pushing a reset button, or by a reset signal internally generated by the system.

During a system reset operation, a host may fetch a set of initialization instructions stored in a non-volatile memory, such as a ROM, EEPROM, or Flash memory. The host then executes the initialization instructions, which may cause system components to be configured and tested, and may cause an operating system or application software, or both, to be copied from a non-volatile memory, such as a hard disk drive or a flash memory, into a memory with fast access times, such as an SRAM or DRAM. The particular set of initialization instructions may vary, depending on the specific hardware and software included in the system.

In the first system reset operation 1000, it is assumed that the system being reset includes a display device having display pixels, which have multiple stable display states, such as an EPD, and a display controller operable to drive the display device. Operations 1004 - 1010 concern initializing the display controller and the display device. Operation 1012 concerns configuring and testing other hardware components of the system and loading software. In the first system reset operation 1000, the system being reset may or may not include an operating system. While operating systems can provide certain features, they increase cost, and in some systems the additional cost may not be justified or the features may not be needed.

In operation 1004, the host reads and starts executing the initialization instructions. In operation 1006, the host configures and activates the display controller. Configuration and activation of the display controller may require writing parameters to registers in the display controller. In operation 1008, the host may cause the display controller to copy a drive scheme, i.e., one set of waveforms, from a non-volatile memory into a volatile memory. Configuration parameters may set clock speeds, panel size, and other factors.

In operation 1010, the host issues a command to the display controller to drive the display device using a reset drive scheme. During the system reset operation 1000, the display states of the display pixels are unknown. In order to accurately drive display pixels to new display states after the reset, it is necessary to place the display pixels in a known display state. After the host issues the command, the host waits until the command completes. The host may pause or wait while the display controller performs a display update operation using the reset drive scheme because the host is single-threaded or lacks an operating system. As mentioned, in one embodiment, the reset drive scheme may be about four seconds in duration.

After the reset drive scheme is complete, the display pixels of the display device are in a known display state, such as black or white. In operation 1012, the host may store data pixels defining an initial start-up screen, such as a logo or a menu, in the image buffer 78 and issue a display update command to the display controller 28 to update the display device 24 with the initial start-up screen. In response, the display controller 28 performs a pixel synthesis and display output operations to render the initial start-up screen on the display device.

In operation 1014, the host may initialize other components of the system, such as ports, memory devices, timers, a wireless modem, etc. In addition, the host may load software and establish a communication connection to other devices or to a network. In block 1016, the execution of initialization instructions is complete and the system is in an active state. The elapsed time to perform system reset operation 1000 may be ten to fifteen seconds.

One reason the first system reset operation takes as long as it does is because the reset drive scheme requires, in one embodiment, four seconds to complete. The length of time needed for a system reset operation may be objectionable to many users. Accordingly, it would be desirable if the reset operation needed to activate a device that includes a display device having multiple stable display states could be sped up.

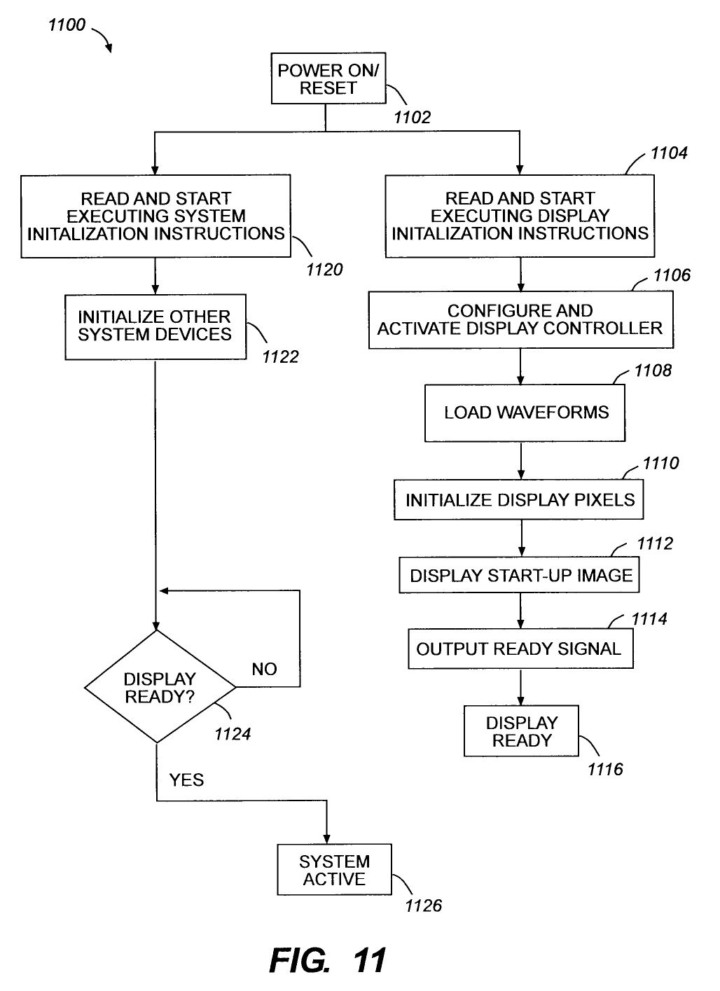

FIG. 11 is a flow diagram illustrating a system reset operation 1100 according to one embodiment. The system reset operation 1100 may be implemented in the system 20 to speed up activation of the system. In an operation 1102, a reset condition is detected. The reset condition may be caused by power being supplied to a system, such as by a user pushing an on/off button. In one alternative, the reset condition may be caused in a system in which power is currently being supplied, such as by a user pushing a reset button, or by a reset signal internally generated by the system.

In operation 1104, the display controller 28 reads and starts executing display initialization instructions. In one embodiment, the display controller 28 may be provided with a hardware reset pin. When the operation 1102 is performed, it is detected by the reset pin. The operation 1104 is performed by the display controller 28 in response to operation 1102. In one embodiment, the display controller 28 may read first initialization instructions from the second memory 104.

In operation 1120, the host 22 reads and starts executing second initialization instructions. In one embodiment, the host 22 may read the second initialization instructions from the first memory 10 or from another suitable memory. The operations 1104 and 1120 may be performed in parallel or at the same time.

In operation 1106, the display controller 28 configures and activates itself. Configuration of the display controller may require writing parameters to registers in the display controller, and may also include writing parameters to registers included in devices coupled with the display controller 28. Configuration parameters may set clock speeds, panel size, etc. The sequence controller 100 may execute instructions, such as those included in the first initialization instructions, to write the required parameters into the configuration registers. Configuration parameters written in operation 1106 may be fetched from the second NV memory 104.

In operation 1108, the display controller may copy a drive scheme, i.e., one set of waveforms, from the waveform memory 34 into a lookup table memory associated with one of the update pipes 84. The drive scheme that is copied in operation 1108 may be a drive scheme for a display pixel reset operation. The sequence controller 100 may execute instructions, such as those included in the first initialization instructions, to cause the drive scheme to be copied into the lookup table memory.

In operation 1110, the display controller drives display pixels 40 of the display matrix 26 using a reset drive scheme in order to place the display pixels into known display states. The sequence controller 100 may execute instructions to initiate a display update command using the reset drive scheme. After the reset drive scheme is complete, the display pixels are in a known display state, such as black or white.

In operation 1112, the display controller 28 may drive display pixels 40 of the display matrix 26 to display an initial start-up screen. The sequence controller 100 may execute instructions to cause display pixels defining initial start-up screen to be read from memory 104 and written to the image buffer 78. In addition, the sequence controller 100 may execute instructions to cause the display controller perform a display update command (pixel synthesis and display output). The initial start-up screen may be a display matrix 26 or one or more display submatrices 52. In one embodiment, the operation 1112 may be omitted. In another embodiment, two or more initial start-up screens may be rendered in succession. For example, a first initial start-up screen may be a logo and a second initial start-up screen may be a menu. As another example, a first initial start-up screen may be a status message in a submatrix 52 window and a second initial start-up screen may be a solid color in a submatrix 52 window, and the first and second initial start-up screens are alternately displayed to render a blinking status message. The blinking initial start-up image may continue until a stop signal is received from the host 22. The stop signal may be signaled by the host 22 by writing a value to a register in the display controller or by asserting a signal on display controller pin.

In operation 1114, the display controller 28 outputs a ready signal in response to detecting a condition. In one embodiment, the ready signal may be output when the waveform for updating the display with the initial start-up screen is complete (operation 1112). In one alternative, the ready signal may be output as soon as the waveform for updating the display with the initial start-up screen has started (operation 1112). In addition, in one embodiment, the ready signal may be output when the reset drive scheme is complete (operation 1110). The display controller 28 may output the ready signal on a “RDY” pin of the display controller, which is coupled with the host 22. In one alternative, a flag may be set in an internal register in the display controller indicating the RDY status. The sequence controller 100 may execute instructions to cause the display controller 28 to output the ready signal.

In block 1116, the execution of the first initialization instructions is complete. the display controller 28 and display device 24 are in active states, and the display pixels 40 of the display device 24 are in a known state. In block 1116, the initial start-up screen or screens may be rendered on the display device. The elapsed time to perform operations 1104 to 1114 may be four to five seconds.

In operation 1122, the host 22 may initialize other components of the system 20, such as ports, memory devices, timers, a wireless modem, etc. The host 22 may write configuration parameters to registers within components or may read data from registers within components. In addition, the host 22 may load software and establish a communication connection to other devices or to a network. In one embodiment, a device other than the host 22 may initialize one or more components of the system 20. The other device may initialize a component in place of the host 22 initializing the component; or the other device may perform an initialization function with respect to a component in addition to an initialization function performed by the host with respect to the component. In operation 1124, the execution of the second initialization instructions is complete and components of the system other than the display controller 28 are in an active state. The elapsed time to perform system operation 1122 may be five to ten seconds. The operation 1120-1122, and the operations 1104 to 1114 may be performed in parallel or at the same time.

In operation 1124, the host 22 may determine if the display controller 28 is in an active state. The host 22 may make this determination by inspecting the state of the ready signal on the “RDY” pin or by reading an internal register of the display controller 28. If the display controller 28 has output the ready signal, then the system reset operation 1100 may be considered complete and the system enters an active state 1126. Because the operation 1122, and the operations 1104 to 1116 may be performed in parallel, the overall time to perform the operations is shorter than that of the first reset operation 1000.

The initial start-up screen (operation 1112) may be a predefined screen, displaying, for example, standard system or user identification information, a standardized welcome, or a menu page. In one embodiment, the initial start-up screen may be a “last user content” page. To illustrate, the display system 20 may be an electronic reader. Two or more different books, magazines, newspapers, or articles may be stored in the first NV memory 10. A user may activate the system and, after navigating one or more menus, begin reading a selected document. The selected document may have two or more pages, each page corresponding with a display matrix 26 of display pixels 40. After display system 20 has displayed the same page for a first predetermined period, the system may assume that user is no longer actively reading the page and update the display device with a privacy image. The privacy image may be artwork, a logo, or another image which is displayed so that unauthorized persons are unable to view the page that had been displayed for the first predetermined period. This page that had been displayed for the first predetermined period may be referred to as the “last user content” page. In one alternative, a “last user content” page may be designated by a user command. After a second predetermined period of inactivity, or as the result of an “off” command by the user, the display system 20 may turn itself off and power down. When the user wishes to resume reading the selected document, the user is required to power on the electronic reader, navigate one or more menus to identify the selected document, and then page through the selected document to find the page where the user left off reading, i.e., the last user content page. The steps required to resume reading may be objectionable to many users who are accustomed to locating where they left off reading in traditional book using a bookmark. It would be desirable to simplify the user process required display a last user content page. In addition, it would be desirable to shorten the time required to render a last user content page on a display device having display pixels that have multiple stable states.

In one embodiment, the last user content page may be stored in the second non-volatile memory 104 and, in operation 1112, the display controller 28 displays as an initial start-up screen the last user content page. The current display page may be stored needs to be stored in the second non-volatile memory 104 as the last user content page may as a result of a variety of conditions. In one embodiment, the current display page may be copied to the second memory 104 as a last user content page when the current display page is replaced with a privacy image. The current display page may be copied to the second memory as a last user content page when the current display page is designated by the user as the last user content page. In one alternative, the current display page may be copied to the memory 104 as a last user content page when system 20 is powered down or enters a sleep mode. In one embodiment, the current display page may be copied to the memory 104 as a last user content page when the current display page is stored into the image buffer 78 before a display update operation. The sequence controller 100 may execute instructions to store a current display page in the second non-volatile memory 104 as the last user content page on the occurrence of a condition. Displaying the last user content page as the initial start-up screen in operation 1112 would simplify the user process required display a last user content page. In addition, the last user content page as the initial start-up screen in operation 1112 would shorten the time required to render a last user content page on a display device having display pixels that have multiple stable states. In one embodiment, the last user content page may be displayed while the system 20 is still performing initialization instructions (operation 1122).

In one embodiment, some or all of the operations and methods described in this description may be performed by hardware, software, or by a combination of hardware and software.

In one embodiment, some or all of the operations and methods described in this description may be performed by executing instructions that are stored in or on a computer-readable medium. The term “computer-readable medium” may include, but is not limited to, non-volatile memories, such as EPROMs, EEPROMs, ROMs, floppy disks, hard disks, flash memory, and optical media such as CD-ROMs and DVDs.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A method comprising:
driving a display device of a system with drive pulses corresponding with a reset drive scheme in response to detecting a reset condition, the display device having display pixels that have multiple stable states, the driving of the display device being performed by a first unit of the system; and
executing first instructions to cause at least one component of the system other than the display device to enter an active state in response to detecting the reset condition, the executing of the first instructions being performed by a second unit of the system,
wherein the driving of the display device by the first unit and the executing of the first instructions by the second unit are performed in parallel.

2. The method of claim 1, further comprising driving the display device with drive pulses corresponding with one or more data pixels of a frame of pixel data using a first drive scheme subsequent to the driving of the display device with drive pulses corresponding with the reset drive scheme, the driving of the display device with the one or more data pixels of the frame of pixel data and the executing of the first instructions being performed in parallel.

3. The method of claim 2, wherein the frame of pixel data defines a start-up image.

4. The method of claim 2, further comprising storing a user-content image in a first memory.

5. The method of claim 4, wherein the frame of pixel data defines the user-content image.

6. The method of claim 4, wherein the first memory includes a non-volatile memory, further comprising storing the user-content image in the first memory before the system enters an off state.

7. The method of claim 2, further comprising performing a pixel synthesis operation on the frame of pixel data prior to driving the display device with drive pulses corresponding with one or more data pixels of the frame of pixel data.

8. The method of claim 1, wherein the reset drive scheme drives the display pixels to one of a white or black display state.

9. The method of claim 1, wherein the display device is an electrophoretic display device.

10. The method of claim 1, further comprising driving the display device successively with drive pulses corresponding with one or more data pixels of a first frame of pixel data and drive pulses corresponding with one or more data pixels of a second frame of pixel data subsequent to the driving of the display device with the reset drive scheme and in parallel with the executing of the first instructions.

11. The method of claim 1, further comprising executing second instructions by the first unit to cause the first unit to enter an active state in response to detecting the reset condition.

12. The method of claim 1, wherein each of the method operations is embodied as a program of instructions on computer-readable media.

13. A display controller, comprising:
a first unit operable to execute first instructions to cause the display controller to enter an active state in response to detecting a reset condition; and
a second unit operable to drive a display device having display pixels that have multiple stable states with drive pulses corresponding with a reset drive scheme in response to detecting the reset condition.

14. The display controller of claim 13, wherein the second unit is operable to drive the display device with drive pulses corresponding with a reset drive scheme independently of a device executing second instructions to cause at least one unit to enter an active state.

15. The display controller of claim 14, wherein the second unit is operable to drive the display device with drive pulses corresponding with a reset drive scheme at the same time that the device executes the second instructions to cause at least one unit to enter an active state.

16. The display controller of claim 14, wherein the second unit is operable to drive the display device with drive pulses corresponding with one or more data pixels of a frame of pixel data using a first drive scheme subsequent to the driving the display device with drive pulses corresponding with the reset drive scheme, the second unit being operable to drive the display device with drive pulses corresponding with one or more data pixels of the frame of pixel data at the same time that the device executes the second instructions to cause the at least one unit to enter an active state.

17. The display controller of claim 16, further comprising a memory to store a start-up image, wherein the frame of pixel data defines the start-up image.

18. The display controller of claim 16, further comprising a memory and a third unit to store a user-content image in the memory before the display controller enters an off state, wherein the frame of pixel data defines the user-content image.

19. The system, comprising:
at least one unit;
a host device operable to execute instructions to cause the at least one unit to enter an active state in response to detecting a reset condition;
an electrophoretic display device; and
an apparatus operable to drive the display device with drive pulses corresponding with a reset drive scheme in response to detecting the reset condition, the apparatus being operable to drive the display device with drive pulses corresponding with the reset drive scheme independently of the executing of the instructions by the host device.

20. The system of claim 19, wherein the apparatus is operable to drive the display device with drive pulses corresponding with one or more data pixels of a frame of pixel data using a first drive scheme subsequent to the driving the display device with drive pulses corresponding with the reset drive scheme, the apparatus being operable to drive the display device with drive pulses corresponding with one or more data pixels of the frame of pixel data independently of the executing of the first instructions by the host device.

21. The system of claim 20, further comprising a memory to store a start-up image, wherein the frame of pixel data defines the start-up image.

22. The system of claim 20, further comprising a memory, wherein the apparatus is operable to store a user-content image in the memory before the system enters an off state, the frame of pixel data defining the user-content image.
